(19) United States
(12) Patent Application Publication
(10) Pub. No.: US 2009/0084563 A1
(43) Pub. Date: Apr. 2, 2009

(54) Shovel for sifting debris from soil

(76) Inventor: Simmonds Amanda, Vancouver, WA (US)

Correspondence Address: Jim Montgomery;8th Floor, 5201 Blue Lagoon Drive, Miami, FL, 33126, US

(21) Appl. No.: 11/986,174

(22) Filed: Nov. 19, 2007

Related U.S. Application Data
(60) Provisional application No. 60/976,476, filed on Oct. 1, 2007.

(51) Int. Cl. A01B 1/02

(52) U.S. Cl. 172/32

(57) ABSTRACT

An apparatus for separating rocks and debris from dirt is presented. The apparatus includes a shovel including a round pointed base, a plurality of holes disposed throughout the base including dimensions smaller than the rocks and debris where, when a user of the shovel digs into the dirt, the user can shake the shovel such that the dirt is sifted through the holes with the rocks and debris remaining on the base and a handle for the user to operate the shovel to dig into the dirt and shake the shovel.

### CROSS-REFERENCE TO RELATED APPLICATIONS

The present Utility patent application claims priority benefit of the [U.S. provisional application for patent Ser. No. 60/976,476 filed on Oct. 1, 2007 under 35 U.S.C. 119(e). The contents of this related provisional application are incorporated herein by reference for all purposes.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to tools. More particularly, the invention relates to a shovel comprising holes that enables a user to sift rocks and other debris from the soil while digging.

### BACKGROUND OF THE INVENTION

When digging, especially in rocky soil, a person often must stop digging in order to remove rocks or other debris from the soil. Currently to remove rocks and debris while digging, a person must bend over and manually remove the rocks and debris. This is time consuming and can be painful because of all of the bending and kneeling required by this method.

In view of the foregoing, there is a need for improved techniques for removing rocks and debris from soil while digging.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary rock sifting shovel, in accordance with an embodiment of the present invention; and

FIG. 2 illustrates an exemplary hand shovel that may be used to sift rocks from the soil while digging, in accordance with an embodiment of the present invention.

Unless otherwise indicated illustrations in the figures are not necessarily drawn to scale.

### SUMMARY OF THE INVENTION

To achieve the forgoing and other objects and in accordance with the purpose of the invention, a shovel for sifting debris from soil is presented.

In one embodiment, an apparatus for separating rocks and debris from dirt is presented. The apparatus includes a shovel including a round pointed base, a plurality of holes disposed throughout the base including dimensions smaller than the rocks and debris where, when a user of the shovel digs into the dirt, the user can shake the shovel such that the dirt is sifted through the holes with the rocks and debris remaining on the base and a handle for the user to operate the shovel to dig into the dirt and shake the shovel. Other embodiments include a lip disposed on a side of the base to retain the rocks and debris on the base and a curvature to hold the rocks and debris on the base. In another embodiment the handle is an appropriate length such that the user can operate the shovel from a standing position. In another embodiment the handle is an appropriate length such that the user can operate the shovel using one hand. In other embodiments the shovel is constructed of metal and the metal is coated to prevent rust. In still another embodiment the handle is constructed of wood.

In another embodiment an apparatus for separating rocks and debris from dirt is presented. The apparatus includes a shovel including a round pointed base, a plurality of holes disposed throughout the base including dimensions smaller than the rocks and debris, a lip disposed on a side of the base to retain the rocks and debris on the base and a curvature to hold the rocks and debris on the base where, when a user of the shovel digs into the dirt, the user can shake the shovel such that the dirt is sifted through the holes with the rocks and debris remaining on the base and a handle for the user to operate the shovel to dig into the dirt and shake the shovel. In yet another embodiment the handle is an appropriate length such that the user can operate the shovel from a standing position. In still another embodiment, the handle is an appropriate length such that the user can operate the shovel using one hand. In further embodiments, the shovel is constructed of metal and the metal is coated to prevent rust. In yet another embodiment, the handle is constructed of wood.

In another embodiment, an apparatus for separating rocks and debris from dirt is presented. The apparatus includes means for digging into dirt where, when a user of the digging means digs into the dirt, the user may shake the digging means such that the dirt is sifted away with the rocks and debris remaining on the digging means and means for the user to operate the digging means to dig into the dirt and shake the digging means.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

The preferred embodiment of the present invention is a rock sifting shovel that enables a user to dig and sift rocks and other debris from the soil with the same tool. The preferred embodiment enables a user to sift out and remove rocks and debris while digging in soils that are heavily laden with rocks. However, embodiments of the present invention may be used in any garden or yard.

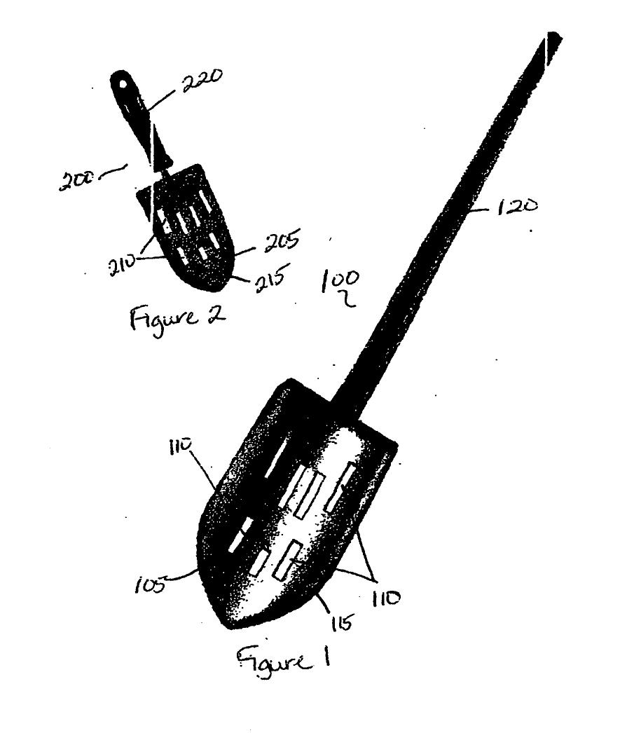

FIG. 1 illustrates an exemplary rock sifting shovel 100, in accordance with an embodiment of the present invention. In the present embodiment rock sifting shovel 100 is a medium shovel that has a round, pointed base 105 with holes 110 spaced throughout base 105. Holes 110 are large enough to allow soil through yet are small enough to generally prevent rocks and debris from passing through holes 110. Base 105 is made of metal; however, in alternate embodiments the base may be made of other materials such as, but not limited to, various plastics. In the present embodiment, base 105 of rock sifting shovel 100 has a lip 115 on the side in order to hold rocks for removal. A handle 120 is an appropriate length for a full sized shovel and generally eliminates bending and kneeling to remove rocks and debris from the soil. Handle 120 can be made of various materials such as, but not limited to, wood, fiberglass, metal, or plastic and, in some embodiments, can be fitted with a grip or D-handle for added comfort and control during use. Additionally, in some embodiments where base 105 is metal, base 105 can be powder-coated to prevent rust.

In typical use of rock sifting shovel 100, the user holds rock sifting shovel 100 with handle 120, scoops an amount of soil with base 105 and gently shakes rock sifting shovel 100. The unique design of the present invention sifts the soil through holes 110 and holds onto any rocks or other debris with lip 115. The length of handle 120 in the present embodiment generally eliminates bending, kneeling, or using hands to manually remove rocks and debris from the soil. After the soil has been sifted through holes 110 in base 105, the rocks and debris that remain in base 105 may be discarded by the user.

Those skilled in the art, in light of the present teachings, will recognize that shovels of practically any size may incorporate holes in the base for sifting rocks and other debris from the soil. For example, without limitation, FIG. 2 illustrates an exemplary hand shovel 200 that may be used to sift rocks and debris from the soil while digging, in accordance with an embodiment of the present invention. In the present embodiment, hand shovel 200 comprises a base 205 with holes 210 and a handle 220. Holes 210 are appropriately sized so as to enable soil to go through while rocks and other debris remain in base 205. The present embodiment also comprises a lip 215 to hold rocks and debris while sifting. Base 205 may be made of a variety of materials such as, but not limited to, various metals and plastics. If metal, base 205 may be powder-coated in some embodiments to prevent rust. Handle 220 may also be made of a range of materials such as, but not limited to, various metals or plastics, fiberglass, wood, etc.

In typical use of hand shovel 200, a user holds handle 220 and picks up an amount of soil with base 205. The user then shakes hand shovel 200 to sift the soil through holes 210 while any rocks or debris remain in base 205. Lip 215 aids in holding the rocks and debris on base 205. Once all of the soil has been sifted out, the user may discard the rocks and debris. Hand shovel 200 is typically used for smaller jobs than rock sifting shovel 100, shown by way of example in FIG. 1, such as, but not limited to, potting plants or planting small plants in a garden or yard.

An alternate embodiment of the present invention may incorporate a base with more curvature than a typical shovel rather than a lip such as, but not limited to, lip 115 or lip 215 shown by way of example in the Figures. The curvature of the base holds rocks and debris, similarly to a bowl, as the user sifts the soil. Other alternate embodiments may incorporate both a lip and an especially curved base. Yet other alternate embodiments may incorporate a conventionally curved base with no lip.

Having fully described at least one embodiment of the present invention, other equivalent or alternative methods of implementing a tool that can sift rocks from soil while digging according to the present invention will be apparent to those skilled in the art. The invention has been described above by way of illustration, and the specific embodiments disclosed are not intended to limit the invention to the particular forms disclosed. For example, the particular implementation of the base may vary depending upon the particular type of shovel used. The shovels described in the foregoing were directed to shovels with round pointed bases; however, alternate embodiments may implement bases with various other shapes such as, but not limited to, blunt bases, rectangular bases, sharply pointed bases, etc. Differently shaped implementations of the present invention are contemplated as within the scope of the present invention. The invention is thus to cover all modifications, equivalents, and alternatives falling within the spirit and scope of the following claims.

What is claimed is:

1. An apparatus for separating rocks and debris from dirt, the apparatus comprising:
a shovel comprising a round pointed base, a plurality of holes disposed throughout said base comprising dimensions smaller than the rocks and debris where, when a user of the shovel digs into the dirt, said user can shake said shovel such that the dirt is sifted through said holes with the rocks and debris remaining on said base; and
a handle for said user to operate the shovel to dig into the dirt and shake the shovel.

2. The apparatus as recited in claim 1, wherein said base further comprises a lip disposed on a side of said base to retain the rocks and debris on said base.

3. The apparatus as recited in claim 1, wherein said base further comprises a curvature to hold the rocks and debris on said base.

4. The apparatus as recited in claim 1, wherein said handle is an appropriate length such that said user can operate said shovel from a standing position.

5. The apparatus as recited in claim 1, wherein said handle is an appropriate length such that said user can operate said shovel using one hand.

6. The apparatus as recited in claim 1, wherein said shovel is constructed of metal.

7. The apparatus as recited in claim 6, wherein said metal is coated to prevent rust.

8. The apparatus as recited in claim 1, wherein said handle is constructed of wood.

9. An apparatus for separating rocks and debris from dirt, the apparatus comprising:
a shovel comprising a round pointed base, a plurality of holes disposed throughout said base comprising dimensions smaller than the rocks and debris, a lip disposed on a side of said base to retain the rocks and debris on said base and a curvature to hold the rocks and debris on said base where, when a user of the shovel digs into the dirt, said user can shake said shovel such that the dirt is sifted through said holes with the rocks and debris remaining on said base; and
a handle for said user to operate the shovel to dig into the dirt and shake the shovel.

10. The apparatus as recited in claim 9, wherein said handle is an appropriate length such that said user can operate said shovel from a standing position.

11. The apparatus as recited in claim 9, wherein said handle is an appropriate length such that said user can operate said shovel using one hand.

12. The apparatus as recited in claim 9, wherein said shovel is constructed of metal.

13. The apparatus as recited in claim 9, wherein said metal is coated to prevent rust.

14. The apparatus as recited in claim 9, wherein said handle is constructed of wood.

15. An apparatus for separating rocks and debris from dirt, the apparatus comprising:
means for digging into dirt where, when a user of said digging means digs into the dirt, said user may shake said digging means such that the dirt is sifted away with the rocks and debris remaining on said digging means; and
means for said user to operate the digging means to dig into the dirt and shake the digging means.
